(19) United States
(12) Patent Application Publication
(10) Pub. No.: US 2008/0101094 A1
(43) Pub. Date: May 1, 2008

(54) Essentially planar lighting system

(76) Inventors: Dania Maccaferri La Spada, Weston, FL (US); Gian Pietro Beghelli, Monteveglio (IT)

Correspondence Address: HOLLAND & KNIGHT LLP, 10 ST. JAMES AVENUE, 11th Floor, BOSTON, MA, 02116-3889, US

(21) Appl. No.: 11/588,763

(22) Filed: Oct. 27, 2006

(51) Int. Cl. F21V 7/04

(52) U.S. Cl. 362/633

(57) ABSTRACT

A lighting system includes an essentially planar panel assembly configured to transmit light. At least one light source is positioned about the periphery of the essentially planar panel assembly and configured to direct light into the essentially planar panel assembly and essentially along a longitudinal axis of the essentially planar panel assembly.

### TECHNICAL FIELD

This disclosure relates to lighting systems and, more particularly, to essentially planar light systems.

### BACKGROUND

Light fixtures may use various types of lighting elements, such as incandescent elements, fluorescent elements, and light emitting diode elements. Light fixtures maybe configured to be mounted in various ways, such as: within suspended ceilings; suspended from traditional ceilings, rigidly affixed to ceilings; and rigidly affixed to walls.

Unfortunately, light fixture employing the above-described lighting elements may be substantially thick (when measured from the lighting surface inward), thus limiting the manner in which the light fixture may be utilized.

### SUMMARY OF DISCLOSURE

Accordingly to a first aspect of this disclosure, a lighting system includes an essentially planar panel assembly configured to transmit light. At least one light source is positioned about the periphery of the essentially planar panel assembly and configured to direct light into the essentially planar panel assembly and essentially along a longitudinal axis of the essentially planar panel assembly.

One or more of the following features may be included. The at least one light source may include at least one light emitting diode assembly. At least one driver circuit may energize the at least one light emitting diode assembly. The lighting system may be configured to fit within a suspended ceiling track assembly. The lighting system may be configured to be suspended from one of more pendant cable assemblies. A bracket assembly may attach the lighting assembly to a surface. A plate assembly may be positioned proximate a first surface of the essentially planar panel assembly and may be configured to reflect at least a portion of the light generated by the at least one light source outward through a second surface of the essentially planar panel assembly. The plate assembly may be constructed of a polished metallic material. An optically-polarizing film may be positioned proximate a second surface of the essentially planar panel assembly. The essentially planar panel assembly may be constructed, at least in part, of a material chosen from the group consisting of: acrylic, glass and polycarbonate. A frame assembly may be positioned about the periphery of the essentially planar panel assembly, such that the frame assembly may be configured to at least partially encapsulate at least a portion of the at least one light source.

Accordingly to another aspect of this disclosure, a ceiling tile assembly includes an essentially planar panel assembly configured to transmit light and fit within a suspended ceiling track assembly. At least one light emitting diode assembly is positioned about the periphery of the essentially planar panel assembly and configured to direct light into the essentially planar panel assembly and essentially along a longitudinal axis of the essentially planar panel assembly.

One or more of the following features may be included. At least one driver circuit may energize the at least one light emitting diode assembly. A plate assembly may be positioned proximate a first surface of the essentially planar panel assembly and configured to reflect at least a portion of the light generated by the at least one light emitting diode assembly outward through a second surface of the essentially planar panel assembly. The plate assembly may be constructed of a polished metallic material. An optically-polarizing film may be positioned proximate a second surface of the essentially planar panel assembly. The essentially planar panel assembly may be constructed, at least in part, of a material chosen from the group consisting of: acrylic, glass, and polycarbonate.

Accordingly to another aspect of this disclosure, a lighting system includes an essentially planar panel assembly configured to transmit light. At least one light emitting diode assembly is positioned about the periphery of the essentially planar panel assembly and configured to direct light into the essentially planar panel assembly and essentially along a longitudinal axis of the essentially planar panel assembly. A frame assembly is positioned about the periphery of the essentially planar panel assembly, such that the frame assembly is configured to at least partially encapsulate at least a portion of the at least one light emitting diode assembly.

One or more of the following features may be included. At least one driver circuit may energize the at least one light emitting diode assembly. The plate assembly may be constructed of a polished metallic material.

### BRIEF DESCRIPTION OF THE DRAWINGS

FIG. 1 is perspective view of a suspended ceiling employing an essentially planar lighting system;

FIG. 2 is a diagrammatic view of a wall-mounted essentially planar lighting system and a ceiling mounted essentially planar lighting system;

FIG. 3 is a diagrammatic view of an essentially planar lighting system suspended from a ceiling;

FIG. 4 is a diagrammatic view of an essentially planar lighting system;

FIG. 5 is a first cross-sectional view of the essentially planar lighting system of FIG. 4;

FIG. 6 is a second cross-sectional view of the essentially planar lighting system of FIG. 4; and

FIG. 7 is a schematic view of a driver circuit for use with the essentially planar lighting system of FIG. 4.

### DETAILED DESCRIPTION OF THE PREFERRED EMBODIMENTS

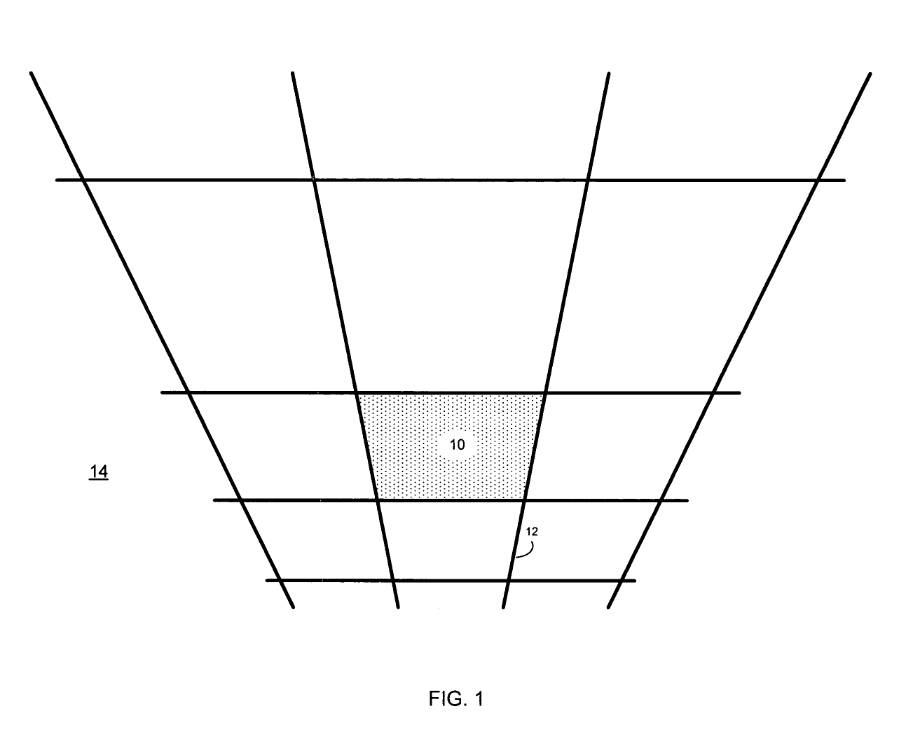

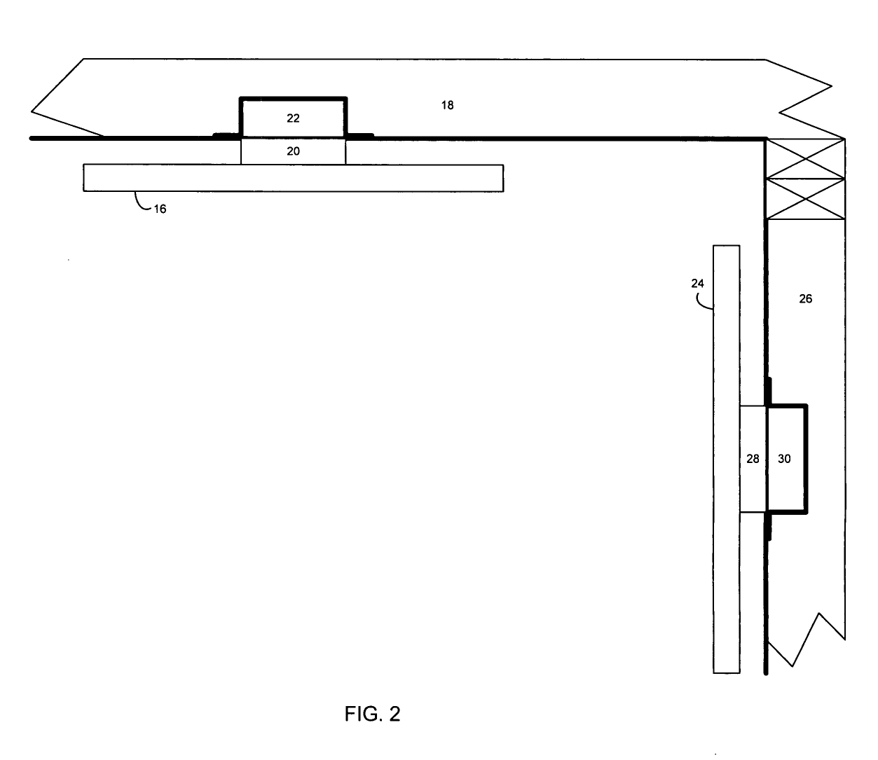

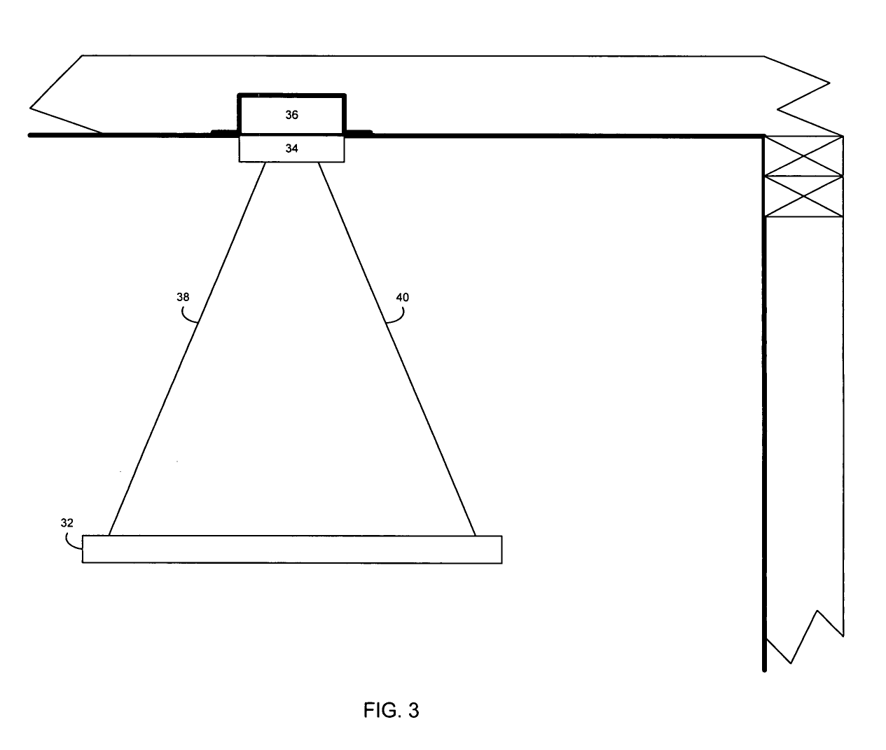

Referring to FIG. 1, there is shown a first embodiment of lighting system 10 that may be configured to be installed within track assembly 12 of suspended ceiling 14. Examples of suspended ceiling 14 may include those manufactured by Armstrong Industries of Lancaster, Pa. Referring also to FIG. 2, there is shown an alternative embodiment lighting system 16 that may be configured to be mounted to ceiling assembly 18 via bracket assembly 20 (which may be coupled to electrical box 22). An alternative embodiment lighting system 24 may be configured to be mounted to a wall assembly 26 via bracket assembly 28 (which may be coupled to electrical box 30). Referring also to FIG. 3, there is shown an alternative embodiment lighting system 32 that may be suspended from mounting plate assembly 34 (which may be coupled to electrical box 36) via one or more pendant cable assemblies 38, 40.

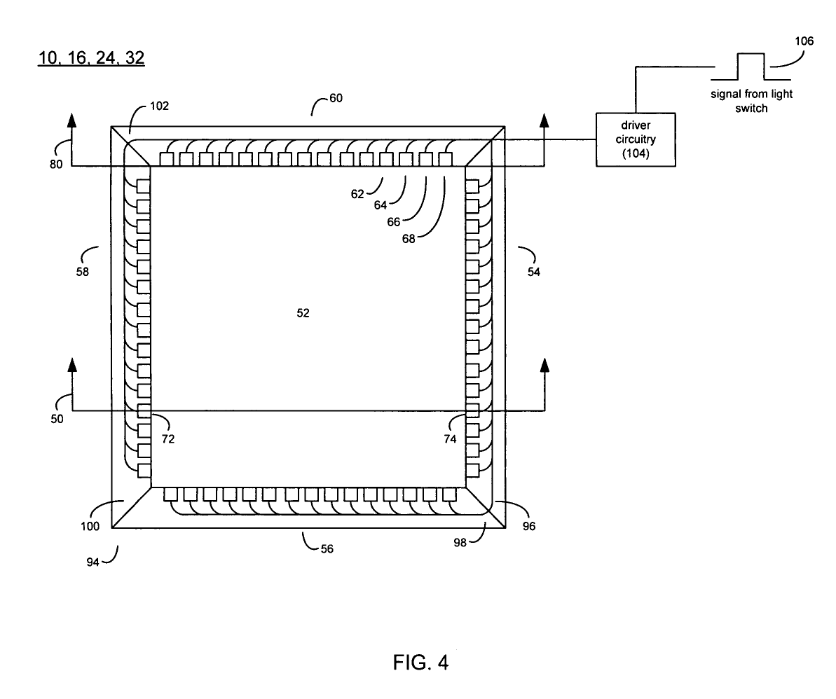

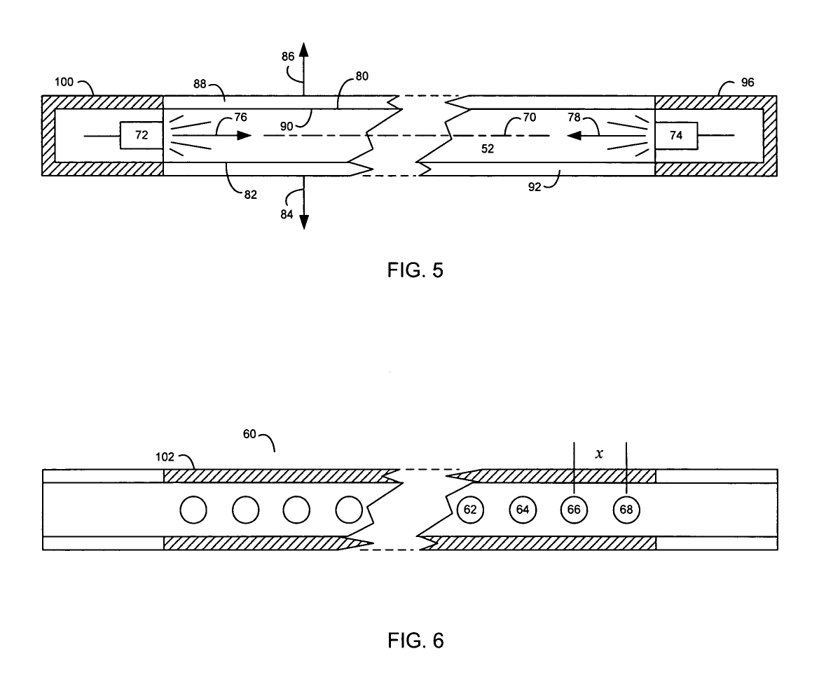

Referring also to FIGS. 4 & 5, there is respectively shown a top view and a cross-sectional side view (along section line 50) of lighting system 10, 16, 24, 32. Lighting system 10, 16, 24, 32 may include an essentially planar panel assembly 52 and one or more light sources 54, 56, 58, 60 positioned about the periphery of essentially planar panel assembly 52.

Essentially planar panel assembly 52 may be constructed of a light transmitting material, such as a polycarbonate material (e.g., Lexan™ by General Electric of Schenectady, N.Y.), an acrylic material (e.g., Lucite™ by The DuPont Corporation of Wilmington, Del.), or another resin-based material. Alternatively, essentially planar panel assembly 52 may be constructed of glass.

Light sources 54, 56, 58, 60 may include one or more light emitting diodes (e.g., light emitting diodes 62, 64, 66, 68) and any required control circuitry (to be discussed below in greater detail). Light sources 54, 56, 58, 60 may be configured to direct light into essentially planer planar panel assembly 52 and essentially along longitudinal axis 70 of essentially planar panel assembly 52.

For example, the cross-sectional view of lighting system 10, 16, 24, 32 is shown to include two light emitting diodes, namely light emitting diode 72 (which is included within light source 58) and light emitting diode 74 (which is included within light source 54). In this particular embodiment, light emitting diodes 72, 74 are each shown to direct light 76, 78 (respectively) into essentially planer panel assembly 52 essentially along longitudinal axis 70.

Referring also to FIG. 6, there is shown a cross-sectional view of lighting system 10, 16, 24, 32 (along section line 80), which illustrates the longitudinal spacing (x) of the light emitting diodes 62, 64, 66, 68 included within light source 60. A typical value for x is 0.50 inches. However, this spacing may be increased or decreased to vary the intensity of the light generated by lighting system 10, 16, 24, 32.

As discussed above, essentially planar panel assembly 52 may be configured to transmit light. Therefore, while e.g., light emitting diodes 72, 74 transmit light into essentially planar panel assembly 52 essentially along longitudinal axis 70, unless constrained, light will exit essentially planar panel assembly 52 through the upper and lower surfaces 80, 82 of essentially planar panel assembly 52. Accordingly, when lighting system 10, 16, 24, 32 is configured to provide direct lighting 84 (e.g., light in a downward direction for direct illumination of an object) and indirect lighting 86 (e.g., light in an upward direction for reflecting off of e.g., a ceiling for indirect illumination of an object), the upper and lower surfaces 80, 82 of essentially planar panel assembly 52 may be left uncovered, thus allowing for light (as generated by light emitting diodes 72, 74) to exit essentially planar panel assembly 52 through both upper surface 80 (as indirect light 86) and lower surface 82 (as direct light 84). Alternatively, if lighting system 10, 16, 24, 32 is configured to only provide direct light 84 (e.g., light in the downward direction for direct illumination of an object), plate assembly 88 may be affixed to and/or positioned proximate upper surface 80 of essentially planar panel assembly 52. Further, if lighting system 10, 16, 24, 32 is configured to only provide indirect light 86 (e.g., light in the upward direction for indirect illumination of an object), plate assembly 88 may be affixed to and/or positioned proximate lower surface 82 of essentially planar panel assembly 52.

Plate assembly 88 may be constructed of an opaque material (e.g., metal or plastic) to prevent the passage of light through upper surface 80 (and/or lower surface 82). Additionally, plate assembly 88 may include polished surface 90 for reflecting light toward lower surface 82 (and/or upper surface 80). For example, plate assembly 88 may be constructed of polished aluminum or vacuum-metalized plastic.

Lighting system 10, 16, 24, 32 may include an optically polarizing film 92 affixed and/or positioned proximate one or more surfaces of essentially planar panel assembly 52. An example of optically polarizing film 92 is Optical Lighting Film manufactured by 3M of Saint Paul, Minn.

Lighting system 10, 16, 24, 32 may include a frame assembly 94 positioned about the periphery of essentially planar panel assembly 52. Frame assembly 94 may be configured to at least partially encapsulate at least a portion of one or more of light source 54, 56, 58, 60. For example, for a square/rectangular essentially planar panel assembly 52, frame assembly 94 maybe be constructed of e.g., four mitered sections 96, 98, 100, 102 of aluminum “U” channel.

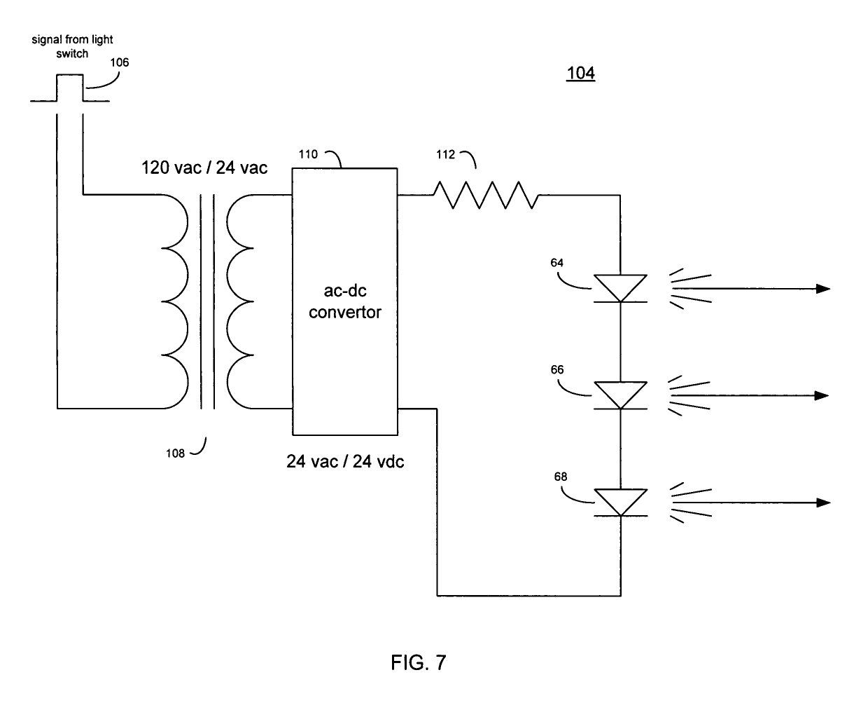

Referring also to FIG. 7, lighting system 10, 16, 24, 32 may include one or more driver circuits 104 for receiving a signal 106 from e.g., a light switch (not shown) and selectively energizing one or more of light sources 54, 56, 58, 60. Driver circuit 104 may include transformer 108 for converting the voltage of signal 106 (e.g., 120 VAC, 208 VAC/277 VAC) to a voltage usable by the various components of driver circuit 104. For example, assume that signal 106 is a 120 VAC signal and transformer 108 has a 5:1 winding ratio, thus reducing the 120 VAC primary-side signal to a 24 VAC secondary-side signal. Driver circuit 104 may include an AC-DC converter 110 for converting the AC signal (e.g., 24 VAC) of the secondary side of transformer 108 to a DC signal (e.g., 24 VDC) usable by the various components of driver circuit 104. Driver circuit 104 may be configured to energize several light emitting diodes (e.g., diodes 64, 66, 68) in a series configuration. Additionally, driver circuit 104 may include one or more resistive devices 112 for regulating the current passing through the light emitting diodes.

For example, assume that AC-DC converter generates a 24 VDC signal that is provided to diodes 64, 66, 68 and resistive device 112. The voltage required to drive a light emitting diode may vary depending on the diode type and the diode color (e.g., blue and white light emitting diodes typically require higher voltages than e.g., red light emitting diodes). Assume for this example that each of light emitting diodes 64, 66, 68 requires a 6 VDC signal to function properly. Accordingly, the following equation may be used to determine the value of resistive device 112:

$$R = \frac{{V}_{s} - \sum {V}_{diodes}}{i}$$

where “i” is the light emitting diode current. Assuming that “i” is 20 milliamps, the above equation is populated as follows:

$$R = \frac{24 - \sum 6 + 6 + 6}{0.020}$$

Accordingly, setting the value of resistive device 112 to 300 ohms results in a voltage drop of 6.00 volts (i.e., 300 ohms×20 milliamps) across resistor 112 while maintaining a 20 milliamp current through light emitting diodes 64, 66, 68.

While driver circuit 104 is described above as including transformer 108, AC-DC converter 110, and resistor 112 for driving diodes 64, 66, 68, this is for illustrative purpose only and is not intended to be a limitation of this disclosure. For example, various switches (not shown) and relays (not shown) may be included within driver circuit 104.

A number of implementations have been described. Nevertheless, it will be understood that various modifications may be made. Accordingly, other implementations are within the scope of the following claims.

What is claimed is:

1. A lighting system comprising:
an essentially planar panel assembly configured to transmit light; and
at least one light source positioned about the periphery of the essentially planar panel assembly and configured to direct light into the essentially planar panel assembly and essentially along a longitudinal axis of the essentially planar panel assembly.

2. The lighting system of claim 1 wherein the at least one light source includes at least one light emitting diode assembly.

3. The lighting system of claim 2 further comprising:
at least one driver circuit for energizing the at least one light emitting diode assembly.

4. The lighting system of claim 1 wherein the lighting system is configured to fit within a suspended ceiling track assembly.

5. The lighting system of claim 1 wherein the lighting system is configured to be suspended from one of more pendant cable assemblies.

6. The lighting system of claim 1 further comprising:
a bracket assembly for attaching the lighting assembly to a surface.

7. The lighting system of claim 1 further comprising:
a plate assembly positioned proximate a first surface of the essentially planar panel assembly and configured to reflect at least a portion of the light generated by the at least one light source outward through a second surface of the essentially planar panel assembly.

8. The lighting system of claim 7 wherein the plate assembly is constructed of a polished metallic material.

9. The lighting system of claim 1 further comprising:
an optically-polarizing film positioned proximate a second surface of the essentially planar panel assembly.

10. The lighting system of claim 1 wherein the essentially planar panel assembly is constructed, at least in part, of a material chosen from the group consisting of: acrylic, glass and polycarbonate.

11. The light system of claim 1 further comprising:
a frame assembly positioned about the periphery of the essentially planar panel assembly, wherein the frame assembly is configured to at least partially encapsulate at least a portion of the at least one light source.

12. A ceiling tile assembly comprising:
an essentially planar panel assembly configured to transmit light and fit within a suspended ceiling track assembly; and
at least one light emitting diode assembly positioned about the periphery of the essentially planar panel assembly and configured to direct light into the essentially planar panel assembly and essentially along a longitudinal axis of the essentially planar panel assembly.

13. The ceiling tile assembly of claim 12 further comprising:
at least one driver circuit for energizing the at least one light emitting diode assembly.

14. The ceiling tile assembly of claim 12 further comprising:
a plate assembly positioned proximate a first surface of the essentially planar panel assembly and configured to reflect at least a portion of the light generated by the at least one light emitting diode assembly outward through a second surface of the essentially planar panel assembly.

15. The ceiling tile assembly of claim 14 wherein the plate assembly is constructed of a polished metallic material.

16. The ceiling tile assembly of claim 12 further comprising:
an optically-polarizing film positioned proximate a second surface of the essentially planar panel assembly.

17. The ceiling tile assembly of claim 12 wherein the essentially planar panel assembly is constructed, at least in part, of a material chosen from the group consisting of: acrylic, glass, and polycarbonate.

18. A lighting system comprising:
an essentially planar panel assembly configured to transmit light;
at least one light emitting diode assembly positioned about the periphery of the essentially planar panel assembly and configured to direct light into the essentially planar panel assembly and essentially along a longitudinal axis of the essentially planar panel assembly; and
a frame assembly positioned about the periphery of the essentially planar panel assembly, wherein the frame assembly is configured to at least partially encapsulate at least a portion of the at least one light emitting diode assembly.

19. The lighting system of claim 18 further comprising:
at least one driver circuit for energizing the at least one light emitting diode assembly.

20. The lighting system of claim 18 wherein the plate assembly is constructed of a polished metallic material.
